(19) United States
(12) Patent Application Publication
(10) Pub. No.: US 2005/0269430 A1
(43) Pub. Date: Dec. 8, 2005

(54) Method and apparatus for reducing drip from spray nozzles

(75) Inventor: Cameron Dwight Bodie, Moose Jaw (CA)

Correspondence Address: FROST BROWN TODD, LLC, 2200 PNC CENTER, 201 E. FIFTH STREET, CINCINNATI, OH, 45202, US

(73) Assignee: Brandt Industries Ltd.

(21) Appl. No.: 10/862,663

(22) Filed: Jun. 7, 2004

(51) Int. Cl. B05B 1/20

(52) U.S. Cl. 239/550; 239/159; 239/726; 239/754

(57) ABSTRACT

A method of reducing drip from a nozzle mounted to a generally horizontally oriented supply conduit comprises reducing the amount of air remaining in the supply conduit when the nozzles are spraying liquid. Conveniently the amount of air remaining in the supply conduit can be reduced by drawing liquid from an upper portion of the supply conduit to supply the nozzle. An apparatus for practicing the method comprises a nozzle secured at the output end of a nozzle conduit wherein the input end of the nozzle conduit is located in an upper portion of the supply conduit.

This application claims priority benefit of Canadian Patent Application Serial No. ______, filed May 11, 2004.

This invention is in the field of equipment for spraying, and in particular such equipment wherein one or more nozzles are connected to a hollow supply conduit to receive liquid to be dispensed from the nozzle.

### BACKGROUND OF THE INVENTION

Spraying equipment in agriculture, construction, and other industries is used for spraying various liquids on surfaces, commonly ground surfaces. In order to cover a wide swath of ground, sprayers typically comprise a substantially horizontal boom with nozzles mounted thereon that are fed from a supply via a conduit. Agricultural sprayers, for example, are typically either wet boom or dry boom sprayers. In a wet boom sprayer, the horizontal boom is a rigid hollow pipe with the nozzles mounted directly to the pipe, and the pipe performs the function of the conduit. In a dry boom sprayer, the horizontal boom is a rigid boom member and the nozzles are mounted on the boom member. A hose or like conduit is connected to each nozzle, or from one nozzle to the next, to supply liquid to the nozzles. Similar sprayers are used for spraying liquid asphalt on road surfaces, and other like situations.

In either a wet or dry boom type sprayer, liquid is pumped into the conduit from a supply and passes through the pipe to the nozzles. Typically controls include a boom valve that directs the output of a pressurized liquid source, typically the liquid output of a pump, either into the conduit to commence the spraying operation when in an on position, or into a return line back to the sprayer tank to cease spraying when in an off position.

Commonly each nozzle includes a drip valve such that a minimum opening pressure must be present in the conduit before the drip valve opens and liquid can reach the nozzle and be sprayed. The conduits can be quite lengthy and so the drip valves prevent liquid from running out of those nozzles closest to the liquid input end of the conduit before liquid reaches the distal end of the conduit farthest from the input. Further, in order for the nozzles to achieve a satisfactory spray pattern for even coverage of the surface to be sprayed, at least some liquid pressure must be present in the conduit, and during spraying the pressure is maintained generally at some desired operating pressure higher than the opening pressure.

Thus when the boom valve is operated to direct liquid into the conduit to initiate spraying, liquid flows into the conduit from the input end toward the distal end and pressure starts to build up in the conduit. When the opening pressure is reached, the drip valves open and the nozzles begin to spray. Some of the air that is present in the conduit may be expelled through some nozzles, but the pressure fairly quickly builds up to the desired operating pressure and liquid is sprayed from all nozzles.

When the boom valve is operated to cease spraying, liquid flow into the conduit stops, and the pressure in the conduit drops as liquid already present in the conduit leaves through the nozzles. When the pressure in the conduit drops to the opening pressure the drip valves close, and liquid flow out the nozzles stops.

It is desirable in most spraying applications to have the nozzles stop spraying as soon as the boom valve is turned to the off position. A problem with current drip valves is that they are set at an opening pressure that is significantly below the typical operating pressures. For example the opening pressure is typically about 12 pounds per square inch (psi), while the operating pressure is typically about 40 psi or higher. Thus the drip valves remain open and liquid passes through the nozzles until the pressure in the supply conduit drops from 40 psi to 12 psi. Setting the opening pressure at a level closer to the typical operating pressure is problematic, because in some situations low pressure spraying is desired, and would not be possible if the opening pressure of the drip valves was higher than the desired low operating pressure.

Prior art sprayers are known where, instead of a boom valve controlling flow to the conduit and drip valves at each nozzle, individually controlled nozzle valves are incorporated into the nozzle body that attaches each nozzle to the boom. The operating pressure is then present in the supply conduit at all times, and flow to the nozzles is directly controlled by the nozzle valves. Such individual nozzle valves overcome the dripping problem of conventional nozzles by providing substantially instant spray on and spray off, however the cost for incorporating and maintaining such a system is significantly higher than the conventional boom valve.

### SUMMARY OF THE INVENTION

It is an object of the present invention to provide a spraying method and apparatus that overcomes problems in the prior art. It is a further object of the present invention to provide such a method that reduces the amount of air in a conduit carrying liquid to a spray nozzle.

It is a further object of the present invention to provide such a method that reduces the amount of air by drawing liquid from an upper portion of the supply conduit to supply the nozzle. It is a further object of the present invention to provide an apparatus that includes an extension to the nozzle conduit such that liquid does not flow out of the nozzle until the liquid level reaches an upper portion of the supply conduit.

It is a further object of the present invention to provide such a method that reduces the amount of air by venting air from the supply conduit when pressurized liquid is directed into the supply conduit.

The present invention provides, in a first embodiment, a nozzle body apparatus adapted for connecting and attaching a nozzle to a generally horizontally oriented supply conduit carrying pressurized liquid. The apparatus comprises a nozzle conduit having an input end located inside the supply conduit when the apparatus is attached to the supply conduit, and an output end. A nozzle is secured at the output end of the nozzle conduit such that pressurized liquid in the supply conduit can enter the input end of the nozzle conduit and flow through the nozzle conduit to the output end thereof and then out through the nozzle. The apparatus is attachable to the supply conduit such that the input end of the nozzle conduit is located in an upper portion of the supply conduit.

The present invention provides, in a second embodiment, an apparatus for spraying comprising a generally horizontally oriented supply conduit connectable at an input thereof to a source of pressurized liquid. A nozzle body is attached to the supply conduit, and a nozzle conduit extends through the nozzle body, the nozzle conduit having an input end located inside the supply conduit and an output end at an outer end of the nozzle body. A nozzle is secured in the outer end of the nozzle body at the output end of the nozzle conduit such that pressurized liquid in the supply conduit can enter the input end of the nozzle conduit and flow through the nozzle conduit to the output end thereof and then out through the nozzle. A vent is operative to allow air inside the supply conduit to escape to the atmosphere as liquid enters the supply conduit when the pressurized liquid source is connected.

The present invention provides, in a third embodiment, a method of reducing drip from a nozzle mounted to a generally horizontally oriented supply conduit. The supply conduit is connectable to a source of pressurized liquid to be sprayed from the nozzle. The method comprises reducing the amount of air remaining in the supply conduit when the supply conduit is connected to the source of pressurized liquid and the nozzles are spraying liquid.

In prior art spraying systems, the nozzle conduit connecting the nozzle to the supply conduit has an input end at the bottom of the supply conduit. As liquid enters the supply conduit to commence spraying it almost immediately covers the input ends of the nozzle conduits, and traps the air present in the supply conduit. Typically such systems include a drip valve in the nozzle conduit, such that flow out through the nozzles is prevented until the pressure in the supply conduit rises to an opening pressure of the drip valves. Liquid then begins to flow through the nozzles, and the pressure in the supply conduit rises to the operating pressure. The trapped air is thus compressed to the operating pressure.

When the liquid flow into the supply conduit is shut off to stop spraying, while no further liquid enters the supply conduit, pressure is maintained therein by the large volume of compressed trapped air. The pressure exerts a force on the liquid left in the supply conduit and forces it out through the nozzles such that the nozzles drip for a significant period of time after it is desired to stop spraying until the pressure of the compressed air drops to a point where the drip valves close. By reducing the volume of air trapped in the supply conduit, the volume of compressed air is reduced and thus much less liquid must leave the supply conduit by dripping from the nozzles in order to reduce the pressure of the trapped air, and the nozzles drip for a reduced time.

Conveniently the amount of air remaining in the supply conduit can be reduced by drawing liquid from an upper portion of the supply conduit to supply the nozzle. An apparatus for practicing the method comprises a nozzle secured at the output end of a nozzle conduit wherein the input end of the nozzle conduit is located in an upper portion of the supply conduit. When liquid enters the supply conduit, it must rise to the upper portion of the supply conduit before it can flow through the nozzle conduit to the nozzle. As it rises it pushes air above it out through the nozzle conduits and nozzles, and so the supply conduit when operating is substantially filled with liquid rather than containing a large portion of compressed air as in the prior art.

Alternatively the nozzle body could be connected to the top of the supply conduit, rather than conventionally being connected to the bottom thereof. The nozzle conduit could thus be oriented so that it enters the top of the supply conduit, rather than conventionally being attached to the bottom thereof. Alternatively again, a vent could be supplied to vent air from the supply conduit when liquid enters the supply conduit to commence spraying.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic front view of a spraying apparatus of the invention;

FIGS. 2 and 3 are a schematic cross-sectional view along lines 2-2 in FIG. 1 showing a nozzle body apparatus of the invention mounted on a supply conduit;

FIGS. 4 and 5 are a schematic cross-sectional views showing a nozzle body apparatus of the prior art mounted on a supply conduit;

FIG. 6A is a schematic cross-sectional view of a nozzle body with a drip valve positioned in the nozzle conduit, and shown in a closed position;

FIG. 6B is a schematic cross-sectional view of the drip valve of FIG. 6A shown in an open position;

FIGS. 7 and 8 are a schematic cross-sectional view along lines 2-2 in FIG. 1 showing a nozzle body apparatus of the invention mounted on a supply conduit with a drip valve positioned in the nozzle conduit;

FIGS. 9 and 10 are a schematic cross-sectional views showing a nozzle body apparatus of the prior art mounted on a supply conduit with a drip valve positioned in the nozzle conduit;

FIG. 11 is a schematic cross-sectional view of an alternate arrangement of the nozzle body and nozzle conduit showing connection to a top of the supply conduit.

FIG. 12 is a schematic front view of an alternate spraying apparatus of the invention showing a vent valve;

FIG. 13 is a schematic cross-sectional view of the vent valve of FIG. 12.

### DETAILED DESCRIPTION OF THE ILLUSTRATED EMBODIMENTS

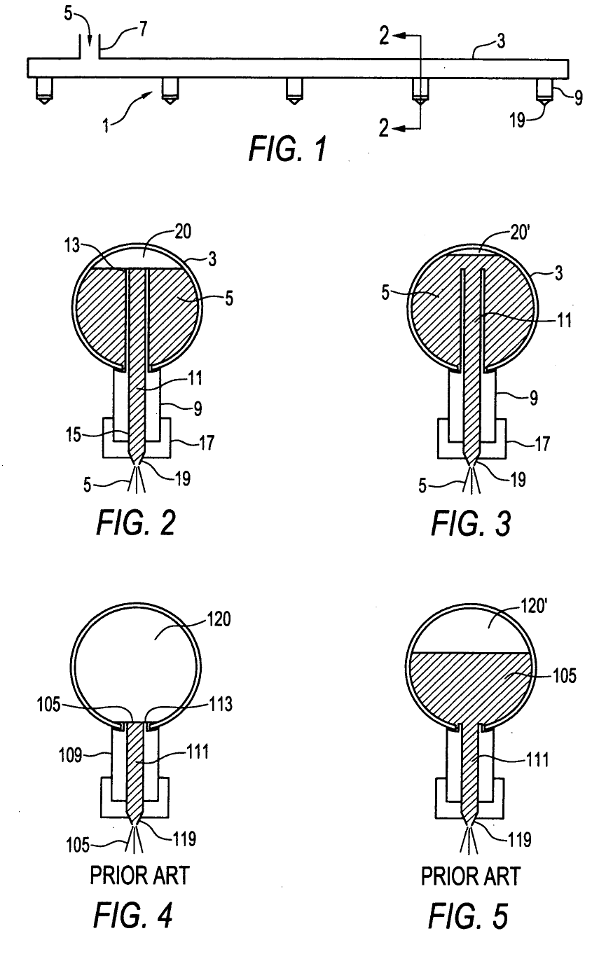

FIGS. 1-3 schematically illustrate a spraying apparatus 1 of the invention. The apparatus 1 comprises a generally horizontally oriented supply conduit 3 carrying pressurized liquid 5 that is pumped into the supply conduit through the inlet 7 from a pump or like pressurized liquid source. A nozzle body 9 is attached to the supply conduit 3 over an aperture through the supply conduit 3 by clamps, by screwing into a threaded aperture in the supply conduit 3, or like means as are well known in the art such that the nozzle body 9 is in sealed communication with the supply conduit 3.

A nozzle conduit 11 extends through the nozzle body 9. The nozzle conduit 9 has an input end 13 located inside the supply conduit 3 in an upper portion of the supply conduit 3 as illustrated in FIGS. 2 and 3, and an output end 15 at a lower end 17 of the nozzle body 9. A nozzle 19 is secured in a lower end 17 of the nozzle body 9 at the output end 15 of the nozzle conduit 11 such that pressurized liquid in the upper portion of the supply conduit 3 can enter the input end 13 of the nozzle conduit 11 and flow through the nozzle conduit 11 to the output end 15 thereof and then out through the nozzle 19.

The lower portion of the nozzle conduit 11 is defined by the nozzle body 9, and an upper portion of the nozzle conduit 11 can comprise a nozzle conduit extension attached to the nozzle body 9 by fitting it into the top end of the nozzle conduit 11 on a prior art nozzle body such that the nozzle conduit extension extends into the supply conduit 3. Conveniently the nozzle body 9 can also be configured such that an upper portion of the nozzle body 9 defining the nozzle conduit 11 extends into the upper portion of the supply conduit 3 when the nozzle body 9 is attached to the supply conduit 3.

In any event the apparatus of the invention comprises a vent operative to allow air inside the supply conduit to escape to the atmosphere as liquid enters the supply conduit when the pressurized liquid source is connected, and reduces drip from the nozzle 19 by thus reducing the amount of air 20 remaining in the supply conduit 3 when the nozzles 19 are spraying liquid. In the illustrates embodiment of FIGS. 2 and 3, the amount of air 20 remaining in the supply conduit 3 is reduced by drawing liquid from an upper portion of the supply conduit 3 to supply the nozzle 19. The vent is here provided by proper orientation of the input end 13 of the nozzle conduit 11 at the top of the supply conduit 3 such that air is pushed out through the nozzle 19 as the liquid 5 rises.

FIG. 2 illustrates the apparatus of the invention and shows that the level of liquid 5 in the supply conduit must rise up into the upper portion of the supply conduit 3 before the liquid 5 can enter the input end 13 of the nozzle conduit 11. Thus when pressurized liquid 5 is directed into the intake 7 of the supply conduit 3 by a sprayer control (not shown), the level of liquid 5 in the supply conduit 3 rises, pushing air that is present in the supply conduit into the input end 13 of the nozzle conduit 11 and out through the nozzle 19. When the liquid 5 rises above the input end 13 of the nozzle conduit 11, the liquid 5 begins to flow out through the nozzle 19.

Once the liquid rises to the level of the input end 13 of the nozzle conduit 11 and begins to flow out of the nozzle 19, the liquid 5 blocks the input end 13 of the nozzle conduit 11 and the air 20 remaining in the supply conduit 3 above the liquid 5 is trapped and compressed as the liquid rises in the supply conduit 3 to the level of FIG. 3, at which point the pressure in the supply conduit is equal to the operating pressure. FIG. 3 illustrates the trapped air 20′ compressed at the operating pressure and occupying a small volume of the supply conduit 3. The closer the input end 13 of the nozzle conduit 11 is to the top of the supply conduit 3, the smaller the volume of air that will be trapped and compressed in the supply conduit 3.

A schematic cross-sectional view of a prior art supply conduit 103 and nozzle body 109 is shown in FIGS. 4 and 5. In contrast to the apparatus of the invention described above, the nozzle conduit 111 of the prior art has the input end 113 of the nozzle conduit 111 located in a lower portion of the supply conduit 103.

Some prior art nozzle conduits are mounted such that the input end is near the middle of the supply conduit with the nozzle body extending frontwards or rearwards. These configurations have been used to provide a horizontal orientation to the nozzle body that is more favorable to mounting a plurality of nozzles on a turret for quick change from one nozzle size to another. The illustrated prior art shows the input end 113 of the nozzle conduit 111 at the bottom of the supply conduit 103, as is more typically the case.

In FIG. 4 it can be seen that when liquid 105 starts to flow into the supply conduit 103, it almost immediately starts to flow into the input end 113 of the nozzle conduit 111 and out through the nozzle 119, and air 120 above the input end 113 of the nozzle conduit 111 is trapped. Thus the supply conduit 103 is substantially full of trapped air 120 that is compressed as the pressure rises to the operating pressure. FIG. 5 illustrates the trapped air 120′ compressed at the operating pressure and occupying a substantial volume of the supply conduit 3.

The supply conduit 3, 103 in both cases thus forms a compressed air reservoir containing a much smaller volume of compressed air 20′ in the supply conduit 3 of the invention, as seen in FIG. 3, compared to the volume of compressed air 120′ in the prior art supply conduit 103 as seen in FIG. 5.

In either case, when the sprayer control is operated to close off the supply of pressurized liquid 5, 105, no further liquid enters but pressure is still exerted in the supply conduit 3, 103 by the compressed trapped air 20′, 120′ which exerts a force on the surface of the liquid 5, 105 that continues to force liquid out through the nozzles 19, 119.

The pressure in the supply conduits 3, 103 drops as liquid 5, 105 flows out of the nozzles 19, 119. The force exerted on the surface of the liquid 5, 105 by the trapped air 20′, 120′ decreases as the liquid 5, 105 flows out the nozzles 19, 119, until the liquid level drops to the level of FIGS. 2 and 4 respectively, when the pressure exerted is back to original atmospheric pressure, as it was when the air was first trapped by liquid blocking the input end 13, 113 of the nozzle conduit 11, 111.

Thus it can be seen that much more liquid 105 must pass out of the nozzles 119 of the prior art system of FIGS. 4 and 5 than in the Applicant's system of FIGS. 2 and 3 before the air ceases to exert pressure pushing the liquid out of the nozzles. Thus the system of the present invention reduces the amount of liquid that drips out of the nozzle after the pressurized liquid source is disconnected from the supply conduit, and thus reduces the length of time that the nozzles drip.

It will be recognized that where the input end of the nozzle conduit is located in the middle of the supply conduit, as in some of the prior art, while a somewhat smaller amount of air is trapped in the supply conduit, the same problems will occur.

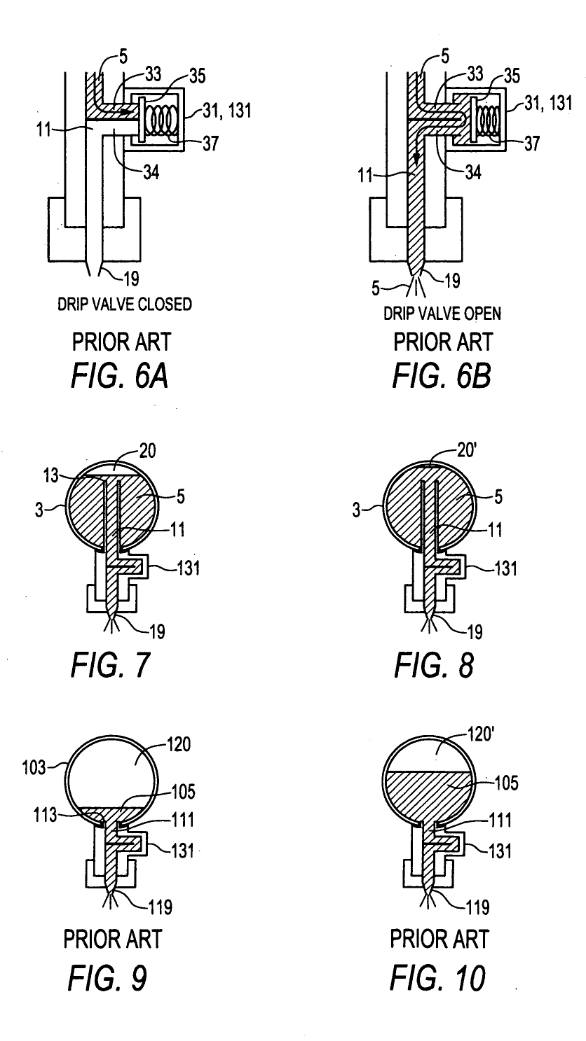

The nozzle conduits 11, 111 of FIGS. 2-5 have been illustrated without a drip valve 31 such as that illustrated in FIGS. 6A and 6B. Such open nozzle conduits 11, 111 are not generally suitable for mobile spraying machines, since as the machine travels the liquid will slosh back and forth. In the prior art system, essentially all the liquid 105 will drain out of the supply conduit 103 through the nozzles, which will only quit dripping when the supply conduit 103 is empty.

This dripping problem in mobile spraying machines is reduced somewhat in the system of the present invention, since much less liquid 5 will drain out of the supply conduit 3 even when moving across the ground with the liquid 5 sloshing back and forth. Liquid will however continue to drip out of the nozzles 19 from time to time, and so it is desirable to position a drip valve 31 in the nozzle conduit 11. The drip valve 31, 131 illustrated in FIGS. 6A and 6B is one commonly used in agricultural sprayers to prevent nozzle drip, and other drip valve mechanisms are known in the art as well. The nozzle conduit 11 comprises a pair of parallel passageways 33, 34. A coil spring 37 exerts a bias force on a seal 35 such that the seal 35 pushes against the ends of the parallel passageways 33, 34 and thus blocks the nozzle conduit 11 to prevent liquid 5 from passing through the nozzle conduit 11 to the nozzle 19.

When liquid present in the nozzle conduit 11 rises to an opening pressure, the liquid pushes the seal 35 against the bias force of the spring 37, and allows the liquid 5 to flow through the end of the top passageway 33 and into the end of the bottom passageway 34, and out through the nozzle 19. Thus liquid at a liquid pressure less than the opening pressure is prevented from passing through the nozzle conduit 11 from the input end thereof to the nozzle 19, and liquid at a liquid pressure greater than the opening pressure passes through the nozzle conduit 11 and out the nozzle 19.

FIGS. 7 and 8 illustrate the operation of the present invention in a system including a drip valve 31 positioned in the nozzle conduit 11. Instead of passing through the nozzle conduit 11 to the nozzle 19 and beginning to spray as soon as the level of the pressurized liquid 5 reaches the input end 13 of the nozzle conduit 11 as in the embodiment of FIG. 2, the pressure in the supply conduit 3 and nozzle conduit 11 must rise to the opening pressure of the drip valve 31, and so the level of the liquid 5 is well above the input end 13 of the nozzle conduit 11 before liquid 5 can begin to flow to the nozzle 19, as illustrated in FIG. 7. The level of the liquid 5 at the operating pressure is illustrated in FIG. 8, and is substantially the same as that of FIG. 3 where there is no drip valve.

Similarly FIGS. 9 and 10 illustrate the operation of the prior art system including a drip valve 131 positioned in the nozzle conduit 111. Here as well the pressure in the supply conduit 103 and nozzle conduit 111 must rise to the opening pressure of the drip valve 131, and so the level of the liquid 105 is well above the input end 113 of the nozzle conduit 111 before liquid 105 can begin to flow to the nozzle 119, as illustrated in FIG. 9. The level of the liquid 105 at the operating pressure is illustrated in FIG. 10, and is substantially the same as that of FIG. 5 where there is no drip valve.

The drip valves 31, 131 function to prevent flow through the nozzles 19, 119 until the opening pressure has been attained in the supply conduit 3, 103. The initial spray pattern is improved, since the nozzles 19, 119 are operating at the opening pressure instead of at essentially zero pressure as is the case where no drip valve is present. Also liquid generally is present at all nozzle locations along the supply conduit 3, 103 and so the nozzles 19, 119 tend to start spraying together, rather than those nearest the input 7 starting to spray first.

As in the apparatuses of FIGS. 2-5, when the sprayer control is operated to close off the supply of pressurized liquid 5, 105, the pressure in the supply conduits 3, 103 drops as liquid 5, 105 flows out of the nozzles 19, 119. The force exerted on the surface of the liquid 5, 105 by the trapped air 20′, 120′ decreases as the liquid 5, 105 flows out the nozzles 19, 119, until the pressure in the supply conduit 3, 103 and nozzle conduit 11, 111 drops to the opening pressure of the drip valve 31, 131 and the liquid level drops to the level of FIGS. 7 and 9. The drip valves 31, 131 then close.

Again, very much less liquid is forced out of the nozzles 19 in the apparatus of the invention illustrated in FIGS. 7 and 8, and thus the time the nozzle drips is reduced.

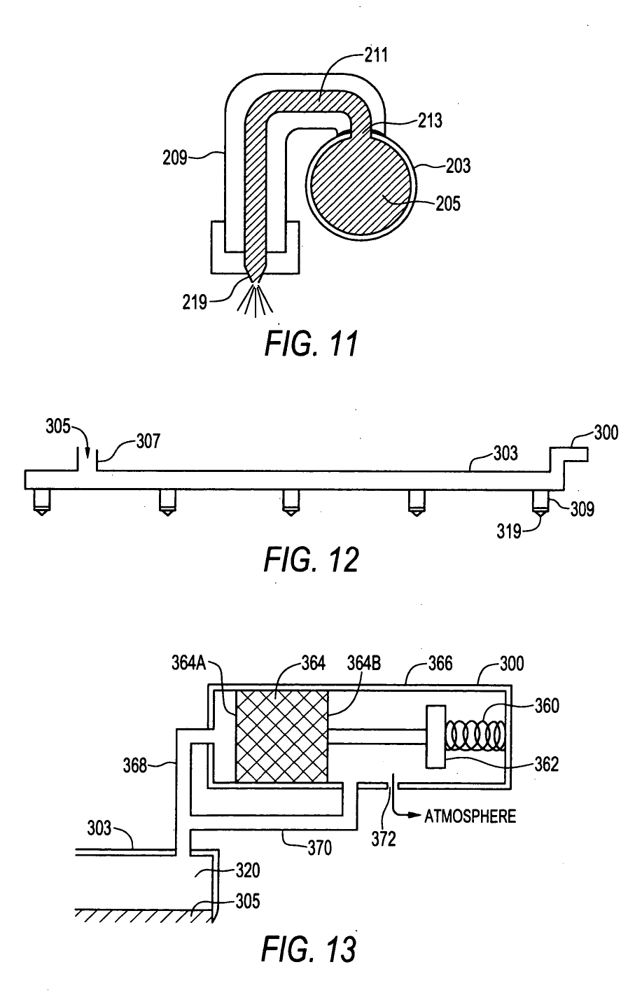

FIG. 11 illustrates an alternate embodiment of the invention wherein the nozzle conduit 211 is also defined by the nozzle body 209, but in this case the nozzle body 209 extends into the supply conduit 203 through an aperture on a top of the supply conduit 203, instead of the bottom as illustrated above. Again the vent is provided by orienting the input end 213 of the nozzle conduit 211 at the very top of the supply conduit 203, such that substantially all air in the supply conduit 203 is forced out through the nozzle conduit 211 and nozzle 219, leaving virtually no air to be trapped and compressed, causing nozzle drip. The supply conduit 203 is substantially filled with liquid 205. A drip valve could also be incorporated into the nozzle conduit 211 to prevent drip from liquid 205 sloshing back and forth during travel when spraying is turned off.

The embodiments of FIGS. 2, 3, 7, and 8 can readily be provided by using a nozzle conduit extension and the common bottom holes provided in typical conventional sprayers. Thus same can be retrofit to existing machines. The embodiment of FIG. 11 could be implemented by modifying the nozzle body 209 to mount on the top of the supply conduit 203, with the nozzle 219 oriented to spray down.

FIGS. 12 and 13 illustrates an alternate embodiment of the invention wherein one or more separate vent valves 300 are provided to vent air 320 from the supply conduit to the atmosphere as the liquid 305 rises in the supply conduit 303. The vent valve 300 is connected to a top portion of the supply conduit 303 and is operative to open and vent air 320 from the supply conduit 303 when the pressure in the supply conduit 303 is below a venting pressure, and is operative to close when the pressure in the supply conduit 303 rises to the venting pressure.

FIG. 13 illustrates one embodiment of a venting valve 300 suitable to provide the required function. A spring 360 exerts a force on a plunger 362 connected to a piston 364 sliding in a cylinder 366. A pressure line 368 connects the interior of the cylinder 366 on the pressure side 364A of the piston 364 to the interior of the supply conduit 303. A vent line 370 also connects the interior of the cylinder 366 on the spring side 364B of the piston 364 to the interior of the supply conduit 303. A vent hole 372 in the wall of the cylinder 336 connects to the atmosphere. When pressure in the supply conduit 303 is below the venting pressure, the spring 360 forces the piston 364 to the left, such that the vent line 370 is open through the vent hole 372 to the atmosphere as illustrated in FIG. 13. As the liquid 305 and pressure in the supply conduit 303 rises, air 320 is vented to the atmosphere through the vent line 370 and vent hole 372. As the pressure in the supply conduit 303 rises, the piston 364 is forced to the right against the force of the spring 360. When the pressure in the supply conduit 303 rises to the venting pressure, the piston 364 has moved to the right far enough to block the entrance of the vent line 370 into the cylinder 366. No further air 320 or liquid 305 can escape, and pressure in the supply conduit 303 rises to the operating pressure during spraying.

A problem with the embodiment of FIGS. 12 and 13 is that some liquid can also be vented as the pressure builds, especially in a mobile sprayer where the supply conduit 303 is not always oriented horizontally.

The method and apparatus of the invention reduces drip from the nozzle 19 by reducing the amount of air 20 remaining in the supply conduit 3 when the nozzles 19 are spraying liquid. In the embodiments illustrated above in FIGS. 2, 3, 7, 8, and 13 the amount of air 20 remaining in the supply conduit 3 is reduced by drawing liquid from an upper portion of the supply conduit 3 to supply the nozzle 19. Thus when liquid 5 begins to flow into the supply conduit 3 from the pressurized liquid source, the liquid level rises in the supply conduit 3 and forces air 20 inside the supply conduit 3 to vent out through the nozzle 19 before the liquid 5 can begin to flow to the nozzle 19.

In the embodiment of FIGS. 12 and 13, the amount of air is reduced by venting the air through a vent valve 300 or the like.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A nozzle body apparatus adapted for connecting and attaching a nozzle to a generally horizontally oriented supply conduit carrying pressurized liquid, the apparatus comprising:
a nozzle conduit having an input end located inside the supply conduit when the apparatus is attached to the supply conduit, and an output end;
a nozzle secured at the output end of the nozzle conduit such that pressurized liquid in the supply conduit can enter the input end of the nozzle conduit and flow through the nozzle conduit to the output end thereof and then out through the nozzle;
wherein the apparatus is attachable to the supply conduit such that the input end of the nozzle conduit is located in an upper portion of the supply conduit.

2. The apparatus of claim 1 comprising a nozzle body attachable to the supply conduit and wherein the nozzle conduit extends through the nozzle body and the nozzle is secured in the nozzle body at the output end of the nozzle conduit.

3. The apparatus of claim 2 wherein the nozzle body is attachable over an aperture in a bottom side of the supply conduit, and wherein a lower portion of the nozzle conduit is defined by the nozzle body, and wherein an upper portion of the nozzle conduit comprises a nozzle conduit extension attached to the nozzle body and extending into the upper portion of the supply conduit when the nozzle body is attached to the supply conduit.

4. The apparatus of claim 2 wherein the nozzle body is attachable over an aperture in a bottom side of the supply conduit, and wherein the nozzle conduit is defined by the nozzle body, and wherein an upper portion of the nozzle body extends into the upper portion of the supply conduit when the nozzle body is attached to the supply conduit.

5. The apparatus of claim 2 wherein the nozzle body is attachable over an aperture in a top side of the supply conduit, and wherein the nozzle conduit is defined by the nozzle body.

6. The apparatus of claim 1 further comprising a drip valve located in the nozzle conduit such that liquid at a liquid pressure less than an opening pressure is prevented from passing through the nozzle conduit from the input end thereof to the nozzle, and liquid at a liquid pressure greater than the opening pressure passes through the nozzle conduit and out the nozzle.

7. An apparatus for spraying comprising:
a generally horizontally oriented supply conduit connectable at an input thereof to a source of pressurized liquid;
a nozzle body attached to the supply conduit;
a nozzle conduit extending through the nozzle body, the nozzle conduit having an input end located inside the supply conduit and an output end at an outer end of the nozzle body;
a nozzle secured in the outer end of the nozzle body at the output end of the nozzle conduit such that pressurized liquid in the supply conduit can enter the input end of the nozzle conduit and flow through the nozzle conduit to the output end thereof and then out through the nozzle;
a vent operative to allow air inside the supply conduit to escape to the atmosphere as liquid enters the supply conduit when the pressurized liquid source is connected.

8. The apparatus of claim 7 wherein the vent is provided by locating the input end of the nozzle conduit in an upper portion of the supply conduit, and such that as the level of liquid in the supply conduit rises, air is forced out of the upper portion of the supply conduit through the nozzle conduit and nozzle.

9. The apparatus of claim 8 wherein the nozzle conduit is defined by the nozzle body, and wherein the nozzle body extends into the upper portion of the supply conduit through an aperture on a bottom of the supply conduit.

10. The apparatus of claim 8 wherein the nozzle conduit is defined by the nozzle body, and wherein the nozzle body extends into the upper portion of the supply conduit through an aperture on a top of the supply conduit.

11. The apparatus of claim 8 further comprising a drip valve located in the nozzle conduit such that liquid at a liquid pressure less than an opening pressure is prevented from passing through the nozzle conduit from the input end thereof to the nozzle, and liquid at a liquid pressure greater than the opening pressure passes through the nozzle conduit and out the nozzle.

12. The apparatus of claim 8 wherein the vent is provided by at least one vent valve connected to a top portion of the supply conduit and operative to open and vent air from the supply conduit when an operating pressure in the supply conduit is below a venting pressure, and operative to close when the operating pressure in the supply conduit rises to the venting pressure.

13. The apparatus of claim 11 wherein the vent is provided by at least one vent valve connected to a top portion of the supply conduit and operative to open and vent air from the supply conduit when an operating pressure in the supply conduit is below a venting pressure, and operative to close when the operating pressure in the supply conduit rises to the venting pressure.

14. A method of reducing drip from a nozzle mounted to a generally horizontally oriented supply conduit, wherein the supply conduit is connectable to a source of pressurized liquid to be sprayed from the nozzle, the method comprising reducing the amount of air remaining in the supply conduit when the supply conduit is connected to the source of pressurized liquid and the nozzles are spraying liquid.

15. The method of claim 14 wherein the amount of air remaining in the supply conduit when the nozzles are spraying liquid is reduced by drawing liquid from an upper portion of the supply conduit to supply the nozzle.

16. The method of claim 15 comprising providing a nozzle conduit connecting the supply conduit to the nozzle, and locating an input end of the nozzle conduit in an upper portion of the supply conduit.

17. The method of claim 16 further comprising providing a drip valve in the nozzle conduit such that liquid at a liquid pressure less than an opening pressure is prevented from passing through the nozzle conduit from the input end thereof to the nozzle, and liquid at a liquid pressure greater than the opening pressure passes through the nozzle conduit and out the nozzle.

18. The method of claim 14 wherein the amount of air remaining in the supply conduit when the nozzles are spraying liquid is reduced by providing at least one vent valve connected to a top portion of the supply conduit at a location removed from the input of the supply conduit, and operative to open and vent air from the supply conduit when an operating pressure in the supply conduit is below a venting pressure, and operative to close when the operating pressure in the supply conduit rises to the venting pressure.

19. The method of claim 18 further comprising providing a drip valve in the nozzle conduit such that liquid at a liquid pressure less than an opening pressure is prevented from passing through the nozzle conduit from the input end thereof to the nozzle, and liquid at a liquid pressure greater than the opening pressure passes through the nozzle conduit and out the nozzle.
